(19) United States
(12) Patent Application Publication
(10) Pub. No.: US 2004/0030575 A1
(43) Pub. Date: Feb. 12, 2004

(54) Research cost recovery and auditing system and method

(75) Inventors: Kirk Fackre, South Hamilton, MA (US); John Moetteli, Geneva 12 (CH)

Correspondence Address: Moetteli & Associes SaRL, Case Postale 486, Geneva 12, 1211, CH

(73) Assignee: Missiontrek Ltd. Co.

(21) Appl. No.: 10/631,713

(22) Filed: Aug. 1, 2003

Related U.S. Application Data
(63) Continuation-in-part of application No. 10/032,405, filed on Dec. 21, 2001.
Application No. 10/032,405 is a continuation of application No. PCT/US00/17409, filed on Jun. 24, 2000.
(60) Provisional application No. 60/402,124, filed on Aug. 8, 2002.

(51) Int. Cl. G06F 17/60

(52) U.S. Cl. 705/1; 705/400; 705/7

(57) ABSTRACT

A computer-readable medium is encoded with a method of silently or actively tracks all browsing activity or time spent on particular web sites and/or local CD ROMs. Whether a user is concerned about the “soft costs” of lost productivity or the “hard costs” of expensive subscription sites, the invention is useful to quantify and allocate these costs.

### Cross reference to Related Applications

This is a continuation-in-part of U.S. patent application Ser. No. 10/032,405, entitled BROWSING METHOD FOR FOCUSING RESEARCH, filed Dec. 21, 2001, and by virtue thereof, claims priority to Jun. 30, 1999, as well as under §120 to Aug. 8, 2002, the filing date of U.S. provisional application serial No. 60/402,124, entitled RESEARCH COST RECOVERY AND AUDITING SYSTEM AND METHOD, the contents of which are incorporated herein by reference thereto and relied upon.

### BACKGROUND OF THE INVENTION

This invention relates to auditing systems, and, more particularly, to a research cost recovery and auditing system and method.

Many professional services firms maintain 100 or more annual subscriptions, and an increasing number are web-based or have a Web component. On-line research costs are increasing and reliable “free” information on the Web is rapidly disappearing. Professional services firms spend thousands or even millions of dollars a year to access on-line research services. Consequently, the pressure for research departments to demonstrate “ROI” (return on investment) is increasing.

Some online services provide a web interface that includes an optional billing reference field to help a user recover or allocate these costs. Each service is different and most do not directly integrate with time and billing systems. Few verify that the billing information has been entered accurately. Most provide no mechanism whatsoever to allocate costs for web-based research. None offer an integrated solution that can track cost related to un-related web-based services.

Software products exist that try to allocate costs globally for work done when using conventional software on a PC. However, none track costs for Internet research on a variety of unrelated sites, selected at the user's discretion, and none are activated upon access to a pre-selected Internet address. Thus, global cost recovery systems gather much irrelevant data that must then be analyzed (which needlessly consumes system resources).

Therefore, what is needed is a system and a method of recovering Internet research costs and for auditing the work of those on the research team that consumes a minimum of system resources. More specifically, what is needed is system and method for selectively tracking time spend online connected to various, often unrelated websites in association with a client billing reference and for enabling review of research habits based on the research and sites visited.

### SUMMARY OF THE INVENTION

A computer-readable medium is encoded with a computerized method of silently or actively tracking all browsing activity or time spent on particular web sites or local CD ROMs to a client matter number of other administrative reference.

The method comprising the steps of, in online research performed by a user on a particular web site and in which a database of resource costs may be interrogated: (a) verifying whether a resource cost is applicable to the on-line research; and (b) if such cost is verified and thus applicable and not already input, prompting the user to input any additional billing information to be associated with the research. Example cost factors include the overhead cost of a particular user or user type, a billing cost of a particular user or user type, and the cost of access to a particular information resource. The cost information is then integrated into a billing statement for payment by the client to whom the use of the resource is attributable.

In an advantage of the invention, whether a user is concerned about the “soft costs” of lost productivity or the “hard costs” of costly subscription sites, the invention is useful to quantify and allocate these costs to clients in proportion to their actual usage.

In a feature of the invention, a tracking module enables an instructor or administrator to track student PC usage.

In another feature, a billing module manages billing information for network files e.g. within a library or a private resources folder.

In another feature, the invention monitors any URL or file passed through a client-resident version of the invention.

In another feature, the invention traps authentication dialogs that are activated upon connection to specific types of resources at a site URL.

In another feature, the invention traps URLs on the client, before the browser accesses it. Thus, proxies do not interfere with the software operation, nor need they integrate with it in any way.

In another feature, the invention stores frequently used URLs, and, if the URL entered is not a valid URL, a dialog asks the user if he wishes that the method apply a search algorithm to find a logical match in a database of prior accessed sites.

In the billing module, an hourly rate per resource is stored and the time passed on the resource is multiplied by this resource hourly rate to calculate the cost to be attributed to the client matter number entered.

In another feature, the user name input is checked against a database of authorized users. If no match is found, an error message is displayed.

In a feature of the invention, an auditor module operates on the server-side and is thus compatible with any browser.

### BRIEF DESCRIPTION OF THE DRAWINGS

FIG. 1 is a flow chart of the method of the invention

FIG. 2 is a flow chart of a cost verifying submethod of the invention.

### DETAILED DESCRIPTION OF THE PREFERRED EMBODIMENT

A cost recovering method is provided which enables a client to evaluate which research services are recoverable and which should be allocated to overhead. The module allows a client to choose which sites to audit, and select which ones will require validated billing information to recover these costs.

An optional auditing module further allows a client to track whom, when and for how long research was conducted on behalf of a particular client. This information provides input to a resource administrator's buying decisions that enable him or her to decide when it's time to renew.

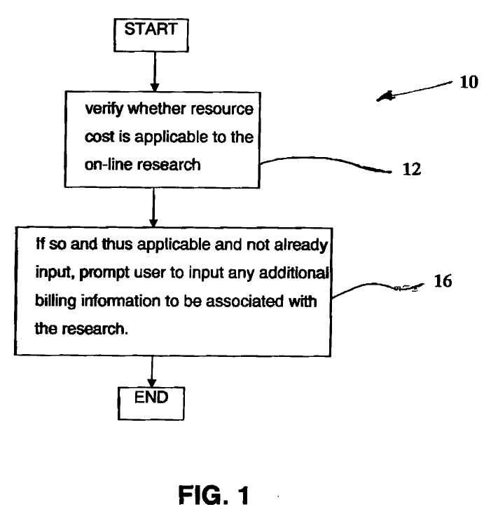

Now referring to FIG. 1, in online research performed by a user on a particular web site and in which a database of resource costs may be interrogated, the method 10 includes two steps. In a first step 12, the method 10 verifies whether a resource cost (shown in Table 1) is applicable to the on-line research. In a second step 16, if such cost is verified and thus applicable and not already input, the user is prompted to input any additional billing information to be associated with the research.

Now referring to the below table, Table 1, of the database of resource costs, is shown. The database of resource costs are input via a dialog query by a system administrator during a setup step. Table 1 includes cost factors such as the overhead cost of a particular user (Bob Jones, for example) or user type (Type A, for example), a billing cost of a particular user or user type, or the cost of access to a particular information resource.

Resource Costs

| Cost factors | Fixed | Variable |
|---|---|---|
| Bob Jones | $80,000/year | |
| Employee type A | $100,000/year | |
| Susan Smith | | $100/hour |
| Employee type B | $200,000/year | |
| www.var.lexis.com | | $150/hour |
| www.fix.westlaw.com | $5000/month | |

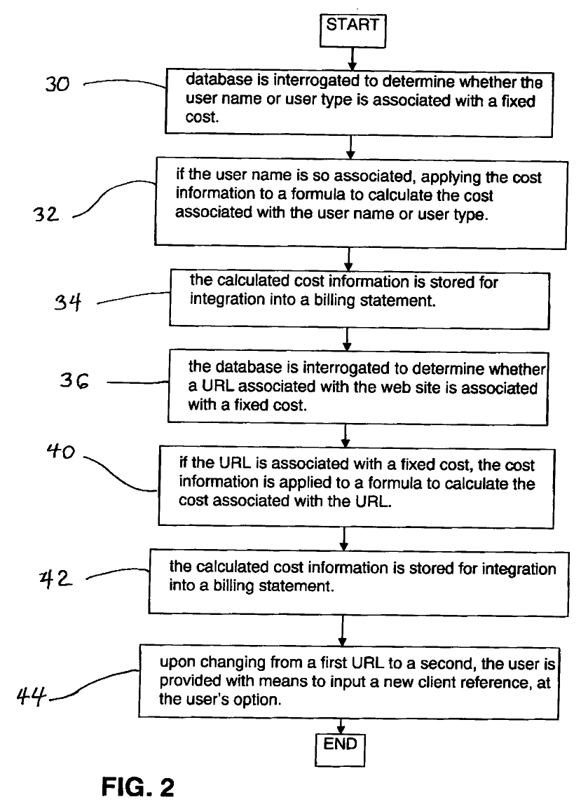

Now referring to FIG. 2, the submethod 12 of verifying whether a resource cost is applicable to the on-line research comprises six substeps. In a first substep 30, the database is interrogated to determine whether the user name or user type is associated with a fixed cost. In a second substep 32, if the user name is so associated, applying the cost information to a formula to calculate the cost associated with the user name or user type. In a third substep 34, the calculated cost information is stored for integration into a billing statement. In a fourth substep 36, the database is interrogated to determine whether a URL associated with the web site is associated with a fixed cost. In a fifth substep 40, if the URL is associated with a fixed cost, the cost information is applied to a formula to calculate the cost associated with the URL. In a sixth substep 42, the calculated cost information is stored for integration into a billing statement. In a seventh substep 44, upon changing from a first URL to a second, the user is provided with means to input a new client reference, at the user's option.

The cost information is integrated into a billing statement via associated software (e.g., Timeslips™ or the like) for invoicing the client.

Optionally, the submethod of verifying whether a resource cost is applicable to the online research comprises the substep of automatically prompting the user to input a user name and client reference, the user name being already associated with a resource cost, in order to permit access to the Internet.

Optionally, the invention includes a mechanism to allow user input and maintenance of a URL table (see Table 2, below) containing an indefinite number of entries. Each URL is flagged as either billable or non-billable. A sample table is provided below:

TABLE 2
URL Table

| URL | Billable |
|---|---|
| http://web2.westlaw.com/signon/default.wl | Y |
| http://medicare.bna.com/ | Y |
| www.latimes.com | N |

When a user accesses a URL flagged as billable, the invention causes a dialog box to pop up with the following non-validated fields, thus prompting the user for input:

TABLE 3
Inputs

| Field Name | Syntax |
|---|---|
| Billing Code | ?-32 digits |

Simultaneously during the research or at pre-selected intervals, such as upon the closing of a research session, billing information (e.g., time passed on a particular URL, the cost associated with that URL, the client matter number) tracked during the research session is posted to the central database and the information therein is synchronized.

Thus, the invention promotes accountability for web-based research performed via Internet Explorer (or other browsing software when accessed, for example, via a browser-independent server-side version).

In a reporting module, enhanced reporting, including detail and summary reports by user and/or by billing code are available using well-known relational database table functions. Cost allocation for fixed cost resources may then be performed in which the total cost for a particular resource is divided portionally among client matter numbers based on the relative time each matter consumed of the total usage of the resource. For example, if resource Z cost a fixed $1000 per month, client A uses resource Z 10% of the time, and client B uses the same resource 90% of the time, then billing data may be generated attributing to client A a $100 charge and to client B a $900 charge.

Thus, fixed resource charges may now be allocated fairly among the clients that use such resources.

Now referring to Table 4, below, when the user inputs a billing code, the invention tracks the user based on the user logon information captured earlier. The invention tracks the date, time, and duration of visit for each URL and the URL(s) visited (A). When the user navigates to a new page on the same domain, the billing time remains active and continues to be associated with the domain (B). When the user navigates off the billable domain to another billable URL, the user is again prompted for a billing code and a new transaction is created (C). Optionally, a popup interface selection is provided which allows default entry of the prior billing code. When the user navigates to a non-tracked domain from a tracked one, the transaction is closed (E). The closing of a transaction means that a cost code is input as null or, alternatively, that the particular transaction is closed, and the data captured is stored for later retrieval, when the billing information for a research session is compiled, depending on administrator or user selections that suits their particular needs.

TABLE 4
Decision Table

| | Navigation Trail | Action |
|---|---|---|
| A | http://medicare.bna.com/ | Prompt for code |
| B | http://www.bna.com/medicare/hcd.htm | Keep billing |
| C | http://web2.westlaw.com/signone/default.wl | Prompt for code, |
| | | create new trx |
| D | www.latimes.com | Close billable trx, |
| | | create nonbill, trx |
| E | www.cnn.com | Close nonbill, trx |

When a user accesses a nonbillable URL, the method silently tracks the above information, assigning a default billing code (e.g. XXXXXX-XXXXX) to the transaction.

Optional software architecture includes a client-side application that interfaces to Internet Explorer (or other similar browser) in the manner described above, or a server side application that collects and logs the browsing activity of all client users regardless of browser used.

Note that the term “browser” or “browsing” when herein used, is meant to include any access of information via software capable of accessing information on a network such as the Internet. Further, “browsing software” is meant to refer to software capable of browsing a network such as the web, the Internet, an intranet, a local drive, a local server the web, or a VPN as well. Therefore, “browsing” to a local server on which are CD-ROMs of data which are subscribed to by the user (and therefore represent a cost) is to be interpreted as being included in these terms.

Preferably, the software operates on a client PC with a Pentium II, 366 MHz, 64 Mb RAM, 20 Mb Free Disk Space, having a Windows 98, NT, 4 SP5, 2000, ME, XP operating system. The preferred server has a Pentium III, 800 Mhz processor, 128 MB RAM, and 500 Mb Free Disk Space, operating with the same OS limitations except that these OSs are for tailored by their software developer for server applications. As for networking, the method supports all standard network protocols, TCP/IP being preferred.

In the client-side version of the invention, the database may be maintained via data entry or ODBC (Open Database Connectivity: see http://www.microsoft.com/data/odbc/default.htm) updates to a local database, such as MS Access™. In a client-server version, the client-side module is setup to synchronize client/matter files with the server-side application, such as an SQL server.

In an advantage, the invention provides accountability for local/or web-based research performed via Internet Explorer or other browsing software

In another advantage of the invention, the data gathered thereby can be used to de-bunk myths of “essential resources”, identifying who uses them, for how long, and how often such resources are used. If sources are not used as expected or promoted, then the subscriptions to these services can be adjusted accordingly.

In a feature of the invention, when a user is prompted for a billing code, the entry is verified against a billing file and if not present, the entry is rejected as invalid. Optionally, the user is then prompted as to whether he wishes to create a new billing file for the transaction.

In another feature, the field name and field syntax of the billing code is configurable by the client via rules (e.g., as shown in Addendum C), syntax and database definitions (e.g. as further described in Addendum A).

In another feature, a mechanism is provided for user-specific “sticky notes” or comments to be associated with each URL. Here the user may jot down the associated login information for that site, or add other page-specific notes as desired.

In another feature, the user can store and pass-through site-specific login and password information for each subscription site.

In another feature, the user may format a billing file so that is can be imported into a time and billing application without further manipulation.

In another feature, the invention monitors any URL or file passed through a client-resident version of the invention, scanning it for undesirable content or high security risk. An administrator or user creates a database of undesirable URLs or file names and/or extension to which each URL input is checked against. A prepackaged database of such undesirable content may also be pre-loaded into the software or optionally loaded upon setup.

In another feature, the invention traps authentication dialogs that are activated upon connection to specific types of resources at a site URL. For example, when such a site is accessed, e.g. .DOC and .PDF files, the server-side or site software asks for a billing/authentication number. The method saves the previously entered billing number in a buffer and enters this number after such an action is confirmed via a confirmation display screen.

In another feature, the invention traps URLs and/or directory paths on the client, before the browser accesses it. Thus, proxies do not interfere or integrate with it in any way.

In another feature, the invention stores frequently used URLs, and, if the URL entered is not a valid URL, a dialog asks the user if he wishes that the invention try to find a logical match among prior accessed sites.

In the billing module, an hourly rate per resource is stored and the time passed on the resource is multiplied by this resource hourly rate to calculate the cost to be attributed to the client matter number entered.

In another feature, the user name input is checked against a database of authorized users. If no match is found, an error message is displayed.

In a feature of the invention, an auditor module operates on the server-side and is thus compatible with any conventional browser.

Multiple variations and modifications are possible in the embodiments of the invention described here. Although certain illustrative embodiments of the invention have been shown and described here, a wide range of modifications, changes, and substitutions is contemplated in the foregoing disclosure. In some instances, some features of the present invention may be employed without a corresponding use of the other features. Accordingly, it is appropriate that the foregoing description be construed broadly and understood as being given by way of illustration and example only, the spirit and scope of the invention being limited only by the appended claims.

What is claimed is:

1. A computer-readable medium encoded with a method of allocating resource costs, the method comprising the steps of, in online research performed by a user on a particular web site and in which a database of resource costs may be interrogated:
(a) verifying whether a resource cost is applicable to the on-line research; and
(b) if such cost is verified and thus applicable and not already input, prompting the user to input any additional billing information to be associated with the research;
wherein, at least one of such cost factors is selected from a group of cost factors consisting of the overhead cost of a particular user or user type, a billing cost of a particular user or user type, and the cost of access to a particular information resource.

2. The method of claim 1, wherein the submethod of verifying whether a resource cost is applicable to the on-line research comprises the substeps of:
(a) interrogating the database to determine whether the user name or user type is associated with a fixed cost;
(b) if the user name is so associated, applying the cost information to a formula to calculate the cost associated with the user name or user type;
(c) storing the calculated cost information for integration into a billing statement;
(d) interrogating the database to determine whether a URL associated with the web site is associated with a fixed cost;
(e) if the URL is associated with a fixed cost, applying the cost information to a formula to calculate the cost associated with the URL; (f) storing the calculated cost information for integration into a billing statement; and upon changing from a first URL to a second, providing the user with means to input a new client reference, at the user's option.

3. The method of claim 1, wherein the cost information is integrated into a billing statement for payment by the client.

4. The method of claim 1, wherein the submethod of verifying whether a resource cost is applicable to the on-line research comprises the substep of automatically prompting the user to input a user name and client reference, the user name being already associated with a resource cost, in order to permit access to the Internet.
